(19) United States
(12) Patent Application Publication
(10) Pub. No.: US 2002/0000699 A1
(43) Pub. Date: Jan. 3, 2002

(54) Vehicle towing system

(76) Inventor: Adam Paul Ruddle, Rednal (GB)

Correspondence Address: Andrew R. Basile, YOUNG & BASILE, P.C., Suite 624, 3001 West Big Beaver, Troy, MI, 48084-3107, US

(21) Appl. No.: 09/894,595

(22) Filed: Jun. 28, 2001

(30) Foreign Application Priority Data
Jun. 29, 2000 (GB) 0015789.1

(51) Int. Cl. B60G 17/01; B60D 1/62

(52) U.S. Cl. 280/5.5; 280/6.15; 280/420

(57) ABSTRACT

Motor vehicle 12 is towed by a second motor vehicle 10. The towed vehicle has a hydraulic or pneumatic suspension with rams 44 at wheels 46, pressure feed hoses 58, height sensors 60, and signal wires 62. Ride height is normally maintained by an electric motor and pump unit 48. Hydraulic control unit 52 and ECU (electrical control unit) 30 co-operate to pressurize and regulate the suspension when ignition switch 38 is activated. Accumulator 55 may be provided to reduce the number of pump cycles. To allow towing of vehicle 12 with suspension height maintained, but ignition switched off, electrical socket 24 is provided on the towed vehicle. This may be connected by cable 26, 28 to socket 16 on the towing vehicle. A spur (41, 43; FIG. 2) may be taken from the cable to provide power to a trailer-type lighting board. The towed vehicle may be an amphibian.

### FIELD OF THE INVENTION

The present invention relates to a vehicle towing system for a towed vehicle having powered fluid suspension. The invention also relates to a vehicle adapted for use as the towed vehicle of such a vehicle towing system.

### DESCRIPTION OF THE RELEVANT ART

A vehicle with a powered fluid suspension system requires the operation of a pump in order to maintain the suspension at the required height for driving. If the pump is not operated, the suspension will tend to deflate over time thereby reducing the ground clearance of the vehicle. Such a pump usually only operates when the engine of the vehicle is running.

During towing of such a vehicle, it is usual that the engine of the towed vehicle is not running. Therefore, up to now it has not been possible to tow a vehicle with powered fluid suspension, because the towed vehicle's suspension “deflates” during towing, thereby reducing ground clearance and causing damage to the vehicle.

### SUMMARY OF THE INVENTION

It is an object of the invention to provide a vehicle towing system in which the above disadvantages are reduced or substantially obviated.

According to the broadest aspect of the present invention there is provided a vehicle towing system comprising a towing vehicle, and a towed vehicle, the towed vehicle having fluid suspension, a pump means for supplying pressurised fluid power to the fluid suspension, an electric motor for driving the pump means, the system further comprising an electrical connection between the towing vehicle and towed vehicle for supplying electrical power from the towing vehicle to the electric motor of the towed vehicle to enable the ride height of the towed vehicle to be maintained during the towing operation.

Preferably the pressurised fluid is pressurised hydraulic oil. Alternatively, the pressurised fluid may be water, which may be mixed with antifreeze or alcohol, or it may be compressed air.

Preferably the electrical connection is provided by a cable connected to the towing vehicle by means of a multi-pin connector socket and plug. The cable may be permanently connected to the electrical system of the towed vehicle, or the towed vehicle may have a further multi-pin connector socket and the cable may have corresponding multi-pin plugs at either end. Preferably the multi-pin connector socket and plug is a conventional seven pin trailer light sockets and plugs. A spur may be taken from the connecting cable to supply electrical power to a light board, which may be attached to the rear of the towed vehicle during towing.

The towed vehicle may have an electrical control unit connected to the electric motor for driving the pump means. Furthermore, sensors may be provided in the fluid suspension of the towed vehicle, which provide feedback to the electrical control unit for monitoring the status of the suspension system. If the electrical control unit detects deflation of the suspension system resulting in reduced ground clearance of the towed vehicle, the electrical control unit provides power to the electric motor which drives the pump means and restores the vehicle suspension to the required driving or towing height. As in normal driving operation of the vehicle, it is preferred that the sensors detect when the suspension system has been restored to the usual driving height. The electrical control unit may then cut off the electrical power supply to the electric motor for driving the pump means.

In accordance with a second aspect of the invention, there is provided a vehicle adapted for use as the towed vehicle of the vehicle towing system in accordance with the first aspect of the invention.

### BRIEF DESCRIPTION OF THE DRAWINGS

The invention will now be described, by way of example only, with reference to the accompanying drawings in which:

FIG. 1 shows a schematic plan of a vehicle towing system in accordance with the invention; and

FIG. 2 is a view similar to that of FIG. 1 but showing a modified vehicle towing system in accordance with the invention.

### DETAILED DESCRIPTION

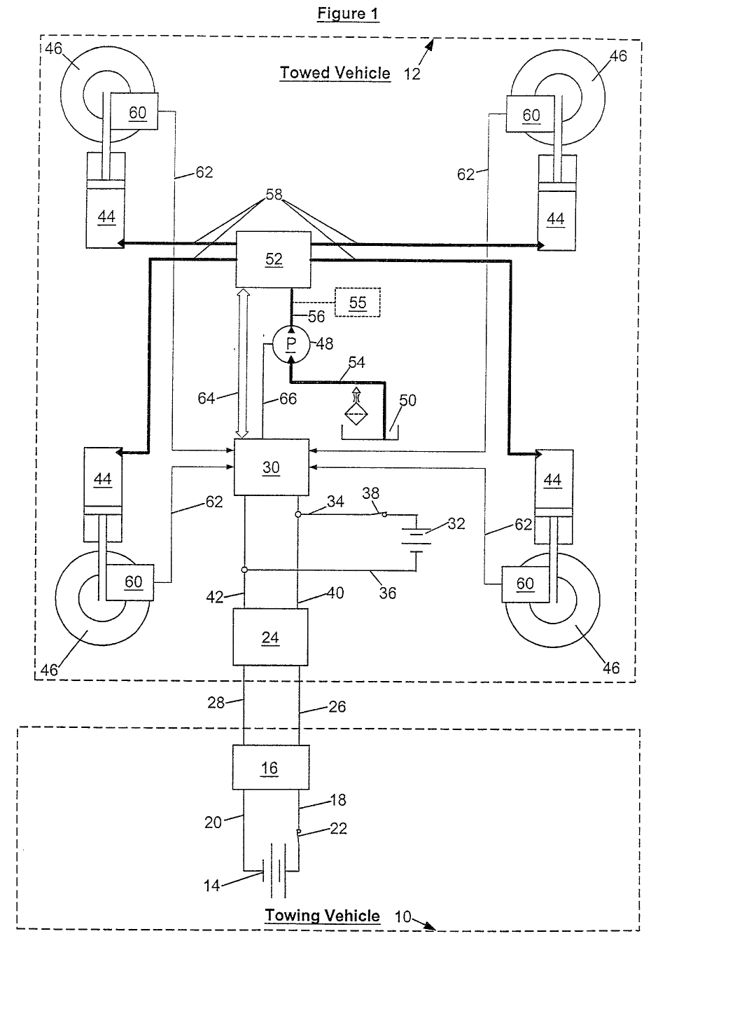

Referring to FIG. 1, a towing vehicle is indicated in dotted outline at 10, and a towed vehicle is indicated in dotted outline at 12. An electrical connector 16 is provided at the rear of the towing vehicle 10, and is connected to a battery 14 of the vehicle by means of positive and negative wires 18, 20 respectively. A vehicle ignition switch 22 is provided in the positive wire 18. When the ignition switch 22 is turned on, the battery 14 and connector 16, are connected, and when the ignition switch is turned off, the battery and connector are disconnected.

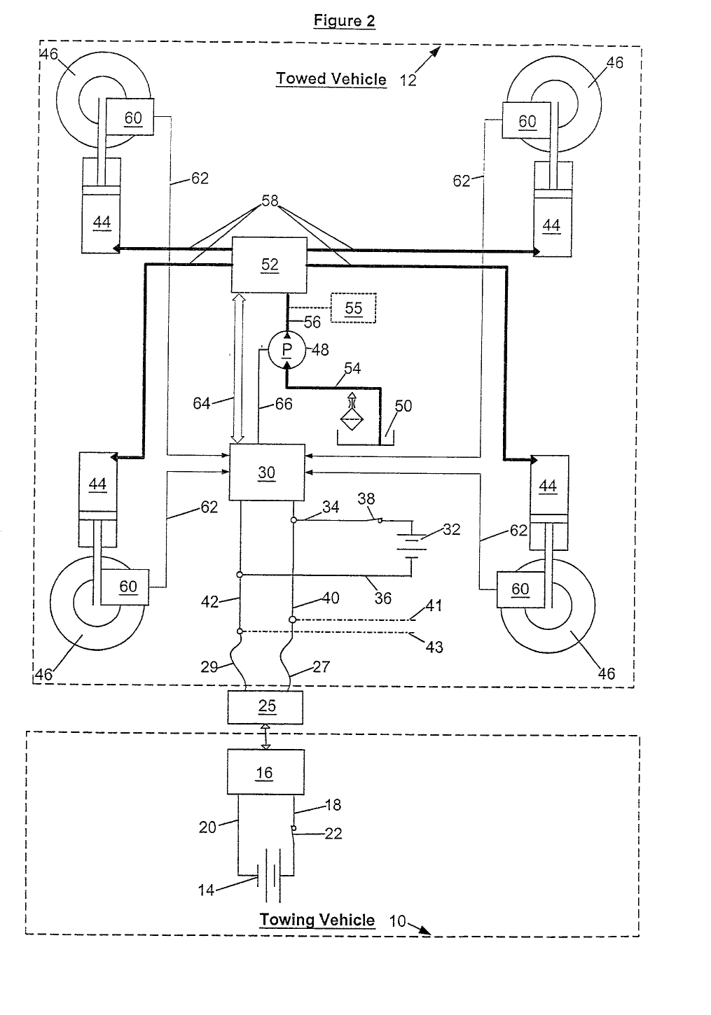

A further electrical connector 24 is provided at the front of the towed vehicle 12, which connector 24 is connected to the connector 16 of the towing vehicle 10 by positive and negative wires 26, 28. The wires 26, 28 are most conveniently part of a single cable, fitted with conventional seven pin trailer cable plugs, and the connectors 16, 24 are correspondingly conventional seven pin sockets. A spur (not shown in FIG. 1 but see wires 41, 43 in FIG. 2) may be taken from the connecting cable to supply electrical power to a light board (not shown), which may be attached to the rear of the towed vehicle 12 during towing.

In normal driving operation of the towed vehicle 12, an electrical control unit (ECU) 30 is connected to a vehicle battery 32 by means of positive and negative wires 34, 36. The positive wire 34 is interrupted by the vehicle ignition switch 38. Therefore, in usual driving conditions the ignition switch 38 must be switched on for power to be provided to the ECU 30. However, the ECU 30 is also connected by positive and negative wires 40, 42 to the connector 24. Consequently power can be provided to the ECU 30 when the ignition switch 38 of the towed vehicle is open. A switch (not shown) may be provided in the positive wire 40, which is positioned in the passenger compartment of the vehicle (not shown).

The towed vehicle 12 has a fluid suspension system, which may be hydraulically or gas operated. The system described below is hydraulic, but the hydraulic components can be replaced with pneumatic components.

A hydraulic cylinder 44 is provided at each of the vehicle wheels 46. The extension of the cylinders 44 determines the ride height of the vehicle. The hydraulic system further comprises a pump 48 having an integral electric motor, a reservoir of hydraulic oil 50 and a hydraulic control unit 52. Hydraulic oil taken from the reservoir 50 via a line 54 is pressurised by the pump 48 and is provided to the hydraulic control unit 52 via a line 56. Solenoid valves (not shown) in the hydraulic control unit 52 direct the pressurised oil to the cylinders 44 as necessary via lines 58.

Height sensors 60 provided at each of the wheels 46 monitor the extension of the cylinders 44 and hence the ride height of the vehicle. Feedback from each height sensor 60 is provided to the ECU 30 by means of a cable 62. The ECU is also electrically connected to the hydraulic control unit 52 and the motor of the pump 48 by means of cables 64, 66 respectively.

When the suspension system of the towed vehicle is powered up, either by the battery 32 through the ignition switch 38, or via the connector 24, the ECU 30 provides power to the motor of the pump 48 in order to pressurise the hydraulic system. The solenoid valves (not shown) in the hydraulic control unit 52 are opened and the hydraulic cylinders 44 are extended. Feedback from the height sensors 60 to the ECU 30 enables the ECU to determine when to close the solenoid valves of the hydraulic control unit 52. The hydraulic cylinders 44 are thereby extended to a predetermined position for a required ride height. The ECU 30 accordingly switches off the motor of the pump 48.

When a height sensor 60 detects deflation of its respective hydraulic cylinder 44, that is, the ride height provided by that cylinder is reduced below the required level, then the ECU powers up the pump 48 and opens the necessary valve in the hydraulic control unit 52. The cylinder 44 therefore extends and when the required predetermined ride height is restored, the valve is shut and the pump motor turned off. Any number of valves in the hydraulic control unit 52 may be open at any point in time as required. The extension of the cylinders 44 and the ride height is thereby maintained at the required predetermined level.

In an alternative embodiment of the invention, an accumulator 55, shown in dotted outline in the Figures, is provided in the line 56 between the pump 48 and the hydraulic control unit 52. This arrangement has the advantage that a smaller flow rate pump 48 can be utilised, and that the pump does not have to be turned on/off for every time that a detector 60 detects deflation of a respective cylinder 44.

In this arrangement, a pressure detector (not shown) monitors the pressure in the accumulator 55, and if the pressure drops below a certain threshold value, then the ECU 30 powers up the pump 48. In this way, a minimum pressure level in the line 56 is maintained, enabling any of the cylinders 44 to be restored at any time by opening a respective valve in the hydraulic control unit 52 as previously described.

A driver is able to set the predetermined ride height according to a mode of travel, for example, off-road mode, road mode and towing mode, selected in the passenger compartment (not shown) by a controller (not shown) linked to the ECU 30. In a further convenient arrangement of the invention, the ECU 30 is provided integral with the hydraulic control unit 52.

A modification to the system of FIG. 1 is shown in FIG. 2, in which the same reference numbers have been used to denote components in common with FIG. 1. In the modified system shown in FIG. 2, the connection between the towed vehicle 12 and the towing vehicle 10 is effected by means of a cable permanently connected to the electrical system of the towed vehicle. The cable comprises positive and negative wires 27, 29 which are permanently connected to, or are an extension of, the positive and negative wires 40, 42 connected to the ECU 30 in the towed vehicle. The cable has a multi-pin plug 25 on its free end for connection with the socket 16 of the towing vehicle. In all other respects the modified system of FIG. 2 is the same as the system of FIG. 1.

Shown in chain dotted lines in FIG. 2 are spur wires 41, 43 which may be provided to supply electrical power a lighting board (not shown) for the towed vehicle 12 in a manner similar to that described above with reference to FIG. 1.

In a preferred embodiment, the towed vehicle is an amphibious vehicle adapted for travel on both land and water. In a particularly preferred embodiment, the towed vehicle is an amphibious vehicle having a suspension system comprising a suspension strut in accordance with the applicant's co-pending international patent application No. PCT/GB01/01334.

1. A vehicle towing system comprising a towing vehicle, and a towed vehicle, the towed vehicle having fluid suspension, a pump means for supplying pressurised fluid power to the fluid suspension, an electric motor for driving the pump means, the system further comprising an electrical connection between the towing vehicle and towed vehicle for supplying electrical power from the towing vehicle to said electric motor of the towed vehicle to enable the ride height of the towed vehicle to be maintained during the towing operation.

2. A vehicle towing system as claimed in claim 1 in which the electrical connection includes a multi-pin connector socket on the towing vehicle and a cable connected to an electrical system of the towed vehicle, one end of the cable having a corresponding multi-pin plug for insertion in the socket.

3. A vehicle towing system as claimed in claim 2 in which the other end of the cable is permanently connected to the electrical system of the towed vehicle.

4. A vehicle towing system as claimed in claim 2 in which the other end of the cable is connected to the electrical system of the towed vehicle by means of a further multi-pin plug and socket connector.

5. A vehicle towing system as claimed in claim 2 in which the multi-pin connector socket is a seven-pin socket.

6. A vehicle towing system as claimed in claim 2 in which a spur is provided in the connecting cable which supplies electrical power for a light board.

7. A vehicle towing system as claimed in claim 2 further comprising an electrical control unit connected to the pump motor.

8. A vehicle towing system as claimed in claim 1 in which the fluid suspension includes a cylinder provided at each wheel of the towed vehicle, extension of the cylinders determining the ride height of the vehicle.

9. A vehicle towing system as claimed in claim 8 in which respective height sensors monitor the extension of each of the cylinders and provide feedback to the electrical control unit.

10. A vehicle towing system as claimed in claim 9 in which a fluid control unit directs pressurised fluid from the pump to each of the cylinders via respective fluid valves and fluid lines.

11. A vehicle towing system as claimed in claim 10 in which the valves of the control unit and the pump motor are operated by electrical power supplied from the electrical control unit in response to feedback from the height sensors.

12. A vehicle towing system as claimed in claim 11 adapted such that the pump motor is operated and a respective valve opened when the height sensor of a cylinder detects deflation of that cylinder below a predetermined extension, the respective valve being closed when the height sensor detects extension of the cylinder to the predetermined extension and the pump motor being switched off provided all the valves are closed.

13. A vehicle towing system as claimed in claim 12 in which any number of valves in the control unit may be open at a given point in time.

14. A vehicle towing system as claimed in claim 1, in which the pressurised fluid is pressurised hydraulic oil.

15. A vehicle towing system as claimed in claim 1, in which the pressurised fluid is compressed air.

16. A vehicle towing system as claimed in claim 10 further comprising a pressurised fluid accumulator for storing pressurised fluid from the pump for subsequent delivery to the cylinders.

17. A vehicle towing system as claimed in claim 1 in which the towed vehicle is an amphibious vehicle.

18. A vehicle adapted for use as the towed vehicle of a vehicle towing system as claimed in claim 1.
